(19) United States
(12) Patent Application Publication
(10) Pub. No.: US 2008/0139180 A1
(43) Pub. Date: Jun. 12, 2008

(54) System And Method For Call Completion On Busy Subscriber (Ccbs) - Feature In A Wireless Communications Network

(75) Inventor: James L. Mills, Frisco, TX (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/721,647

(22) PCT Filed: Dec. 30, 2004
(86) PCT No.: PCT/US2004/043863

§ 371 Date: Jun. 13, 2007

(51) Int. Cl. H04M 3/42

(52) U.S. Cl. 455/414.1

(57) ABSTRACT

Disclosed are systems and methods that allow user-initiated call completion after receiving a busy signal to a called number. The user initiates a request, which is routed to an USSD application server (18). In certain embodiments, the USSD application server (18) may perform the following process: receiving a USSD request containing the phone number of the called party (22) and the MSISDN or telephone number of the calling party (11), determining whether the called number belongs to a recognized wireless network, responsive to the determining step, sending a USSD Request message to the called number requesting the establishment of a USSD session/dialog between a USSD application Server (18) and the called party's mobile terminal (22), wherein the called party's mobile terminal (22) notifies the USSD application server (18) when it reverts from busy to idle state.

### TECHNICAL FIELD

The invention relates in general to communications networks, and in particular to call completion on BUSY features in a wireless communication network.

### BACKGROUND INFORMATION

Many land-based or “wireline” communications networks provide a feature that allows a calling party to “camp on” to a called party's number after the calling party has received a busy signal. Such features are implemented for wireline users as a CLASS service (i.e. CLASS Automatic Callback). With wireline services, when the caller (e.g., Subscriber A) encounters BUSY while calling a called party (e.g., Subscriber B), Subscriber A can hang-up and dial an auto-callback service code. This causes an agent in Subscriber B's serving switch to monitor the status of Subscriber B. Thus, when Subscriber B hangs-up, the agent in his switch notifies another agent in Subscriber A switch (via TCAP signaling). The switch for Subscriber A then calls Subscriber A, and sets up a call from Subscriber A to Subscriber B (assuming that Subscriber A is still in an idle or “IDLE” state).

In wireless networks (such as GSM or WCDMA), such “camp-on” services are commonly known as Call Completion on BUSY Subscriber (“CCBS”). The CCBS feature is more difficult to implement in a mobile environment, because the camped-on mobile can move to another “switch” while maintaining the call.

CCBS has been standardized in the 3^{rd} Generation Partnership Project (“3GPP”) specifications. For instance, see TS 23.093, version 5.0.0, Release 5 “Technical Realization of Completion of Calls to Busy Subscriber,” which is hereby incorporated by reference. In TS 23.093, the wireless network is required to support the Source Service Access Point (“SSAP”) protocol, and to support monitoring of subscriber status. This method can work with wireline subscribers, but requires that the protocol and functionality is supported in the wireline switches. It also involves additional overhead and delay. What is needed, therefore, is a system or method which provides CCBS features in a fast and efficient manner.

### SUMMARY

In response to these and other problems, in one embodiment, there are disclosed systems and methods that allow user-initiated call completion after receiving a busy signal to a called number. The user initiates a request which is routed to an application server. In certain embodiments, the application server may perform the following process: receiving a USSD request containing: the phone number of the called party and the MSISDN or telephone number of the calling party, determining whether the called number belongs to a recognized wireless network, responsive to the determining step, sending a USSD Request message to the called number requesting the establishment of a USSD session/dialog between an USSD application Server and the called party's mobile terminal, wherein the called party's mobile terminal notifies the USSD application server when the on-going call has been completed such that a call can be completed between the calling party and the called party.

Certain aspects of the present invention provide for CCBS features while greatly reducing the load on the wireless communication network. Instead of using SSAP and/or Session Initiated Protocol (“SIP”) signaling for providing CCBS features, certain aspects of the present invention uses circuit-switched signaling. In particular, aspects of the present invention use circuit-switched Unstructured Supplementary Services Data (USSD) messages to implement CCBS features. USSD is a circuit-switched service that allows proprietary services to be overlaid on existing mobile networks, with only generic support of the USSD mechanisms in the networks. Because USSD is a circuit-switched service and utilizes dedicated signaling connections between the terminal and network-based applications, USSD is not normally considered for use as a bearer for providing such services as CCBS.

Using a USSD protocol, therefore, allows faster communications than conventional methods, thereby reducing delay experienced by the mobile users. Furthermore, in some embodiments, the feature logic may be implemented in the mobile phones, which means that the wireless networks need not support the SSAP protocol.

These and other features, and advantages, will be more clearly understood from the following detailed description taken in conjunction with the accompanying drawings. It is important to note the drawings are not intended to represent the only aspect of the invention.

### BRIEF DESCRIPTION OF THE DRAWINGS

FIG. 1. is a schematic illustration of a network incorporating various aspects of the present invention.

FIG. 2 is a call-flow diagram illustrating various aspects of the present invention.

FIGS. 3a and 3b illustrate a process running on a network node, such as an application server, which may implement various aspects of the present invention.

FIG. 4 illustrates a process running on a mobile phone.

FIG. 5 illustrates an alternative process running on a mobile phone.

### DETAILED DESCRIPTION

For the purposes of the present disclosure, various acronyms are used, and the definitions of which are listed below:
3GPP Third Generation Partnership Project
CCBS Call Completion on BUSY Subscriber
GSM Global System for Mobile Communications. Digital cellular telephone standard.
HLR Home Location Register. Permanent SS7 database used in cellular networks to identify the subscriber, identify features or services sub scribed, and track the current location of the mobile subscriber. The Home Location Register (HLR) is in charge of the management of mobile subscribers.
HPLMN Home Public Land Mobile Network
MAP Mobile Application Part
MSC Mobile Switching Center—constitutes the interface between the radio system and the fixed networks. The MSC performs all necessary functions in order to handle the circuit switched services to and from the mobile stations.
MSISDN Mobile Station ISDN. The telephone number of a mobile station.
SIM Subscriber Identity Module
SMS Short Message Service
   A text message service that enables short messages of generally no more than 140-160 characters in length to be sent and transmitted from a cellphone. SMS was introduced in the GSM system and later supported by all other digital-based mobile communications systems. Unlike paging, but similar to e-mail, short messages are stored and forwarded at SMS centers, which means you can retrieve your messages later if you are not immediately available to receive them. SMS messages travel to the cellphone over the system's control channel, which is separate and apart from the voice channel.
SS7 Signaling System No. 7
SSAP Source Service Access Point
TCAP Transaction Capability Application Part—TCAP messages are used to support non circuit-related, connectionless information exchange. Among other things, TCAP messages are used to send queries to databases (such as toll-free [freephone] databases) and to return the database response.
TCP/IP Transmission Control Protocol/Internet Protocol
TE Terminal Equipment
UE User Equipment
UMTS Universal Mobile Telecommunications System. Third generation wireless standard for supporting data transfer rates of 144 kbs
USIM UMTS Subscriber Identity Module
USSD Unstructured Supplementary Services Data—USSD is a means of transmitting information or instructions over a GSM network. USSD has some similarities with SMS since both use the GSM network's signaling path. Unlike SMS, USSD is not a store and forward service and is session-oriented such that when a user accesses a USSD service, a session is established and the radio connection stays open until the user, application, or time out releases it. This has more in common with Data than SMS. USSD text messages can be up to 182 characters in length.
VLR Visitor Location Register—is the location register for Circuit Switched (CS) services. When a MS enters a new location area it starts a registration procedure. The MSC in charge of that area notices this registration and transfers to the Visitor Location Register the identity of the location area where the MS is situated.
WAP Wireless Application Protocol
WCDMA Wideband Code Division Multiple Access—is one of the main technologies for the implementation of third-generation (3G) cellular systems. It is base on radio access technique proposed by ETSI Alpha group and the specifications was finalized 1999.

Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

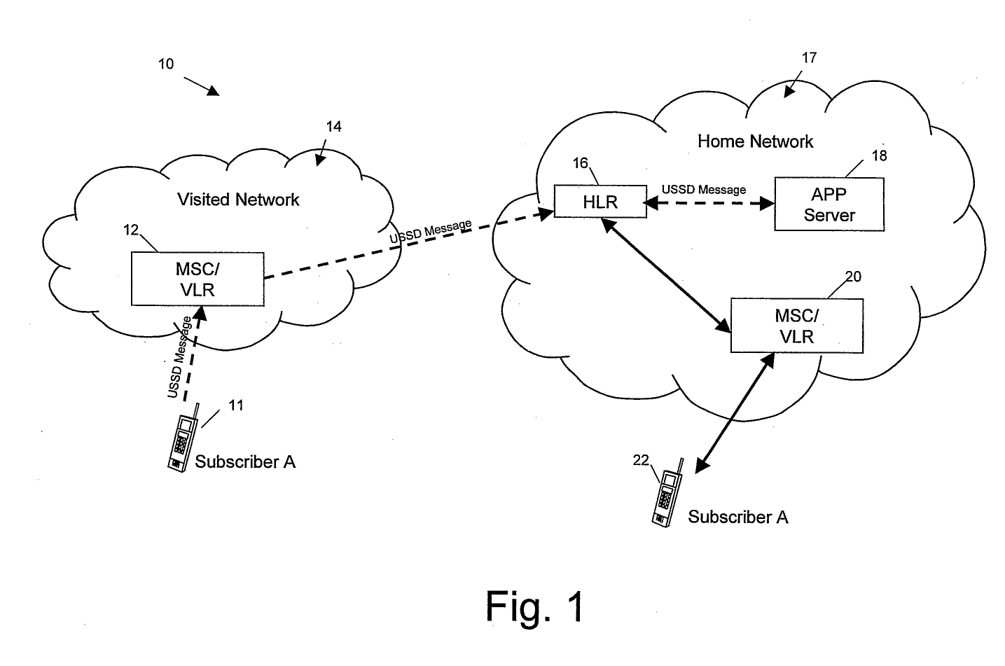

Turning now to FIG. 1, there is presented an example system 10 which incorporates various aspects of the present invention. The system 10 includes a first mobile phone or User Equipment (“UE”) 11 operated by a first user (e.g., Subscriber A). In this illustrative embodiment, the first UE 11 is in communication with a Mobile Switching Center (“MSC”) and/or a Visitor Location Register (“VLR”) 12 of a visited network 14.

In some networks, the MSC constitutes the interface between the radio system and the fixed land-based networks. Typically, the MSC performs all necessary functions in order to handle the circuit switched services to and from the mobile stations. The VLR is the location register for Circuit Switched (CS) services. When a User Equipment enters a new location area, it typically starts a registration procedure. The MSC in charge of that area notices this registration and transfers to the VLR the identity of the location area where the MS is situated.

In turn, the VLR may be in communication with a Home Location Register (“HLR”) 16 in a home network or Home Public Land Mobile Network (“HPLMN”) 17. The HLR 16 may include a permanent SS7 database used in cellular networks to identify the subscriber, identify features or services subscribed, and track the current location of the mobile subscriber. The HLR 16 is typically responsible for the management of mobile subscribers.

As will be explained in detail below, some aspects of this invention uses an application server 18 in communication with the HLR 16. In some embodiments, the application server 18 may be an external USSD application server. Via the HLR 16, the application server 18 may also be in communication with a MSC/VLR 20 which serves a second User Equipment (“UE”) 22 operated by a second user (e.g., Subscriber B).

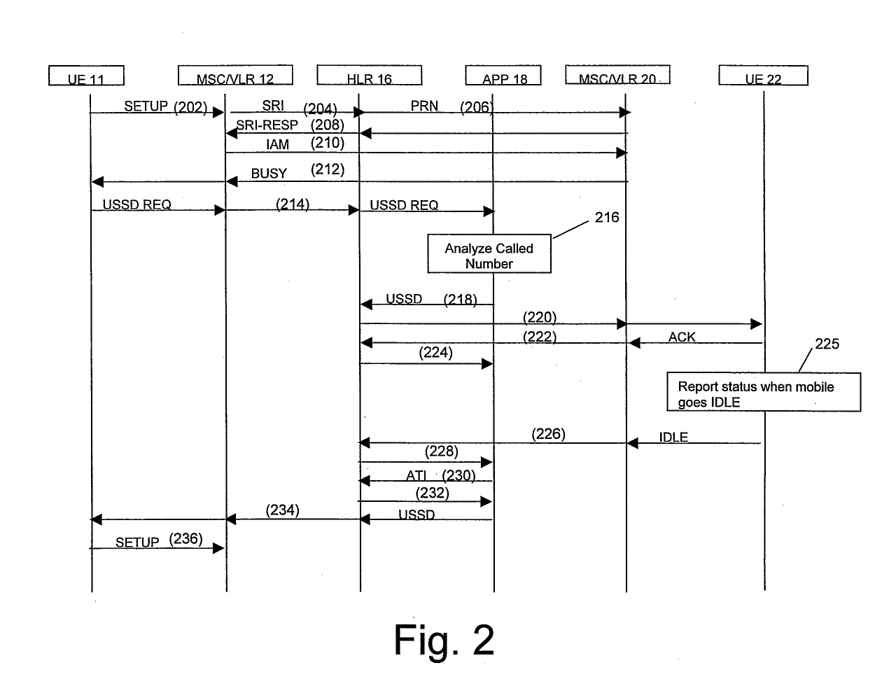

Turning now to FIG. 2, there is presented an illustrative call flow procedure 200 which could incorporate various aspects of the present invention. In this example, the first subscriber or “Subscriber A” attempts to call a second subscriber or “Subscriber B.” Thus, in step 202, the UE 11 sends a call setup message to the MSC/VLR 12, which converts the message to a SRI Send Routing Information (“SRI”) message. In step 204, the SRI message is then forwarded to the HLR 16. In response, in step 206, the HLR 16 forwards a Provide Roaming Number (“PRN”) message to the MSC/VLR 20 in a conventional manner. In step 208, the MSC/VLR 20 sends a response (SRI-RESP) to the MSC/VLR 12 in a conventional manner. The MSC/VLR 12 then sends an Initial is Address Message (“IAM”) to the MSC/VLR 20 to continue the call setup (step 210). In this illustrative situation, the MSC/VLR 20 knows that the User Equipment 22 is busy and in step 212 sends the appropriate busy indication signal to the MSC/VLR 12, which forwards the busy signal to the UE 11. Thus, in response to the call attempt, Subscriber A receives a busy signal.

In some embodiments, Subscriber A can then hang up and enter an Unstructured Supplementary Services Data (“USSD”) activation code (e.g. *36#) followed by the phone number of the called party (e.g., the MSISDN of the User Equipment 22). In other embodiments, an Auto-Callback key on the User Equipment 11 could be used to initiate the callback feature. In such an embodiment, the MSISDN of the last call attempt may be automatically included in a USSD message by the User Equipment 11.

The USSD protocol is a means of transmitting information or instructions over a GSM network. As those skilled in the art will appreciate, USSD has some similarities with Short Message Service (“SMS”) because both use the GSM network's signaling path. Unlike SMS, USSD is not a store and forward service and is session-oriented such that when a user accesses a USSD service, a session is established and the radio connection stays open until the user, application, or time out releases it. USSD text messages can be up to 182 characters in length.

Turning back to FIG. 2, in step 214, a USSD Request message may be routed (via the MSC/VLR 12) to the HLR 16 in the home network 17 in a conventional manner. The HLR 16 forwards the USSD Request message to the application server 18. In some embodiments, the application server 18 is an external USSD application server. Furthermore, in certain scenarios the USSD request is forwarded to the application server 18 via a USSD gateway (not shown). A USSD gateway typically converts SS7 MAP USSD signaling from the HLR into TCP/IP compatible messages, for forwarding to network nodes, such as an external application server.

In step 216, the application server 18 analyzes the called number. As will be explained below, in some embodiments, a called number is analyzed to determine if the called number belongs to an unrecognized mobile network. If the called number belongs to an unrecognized number, then the USSD application will reject the request from Subscriber A. In the areas where numbers may be ported, such as the United States, additional queries may be made to determine a correct routing number.

Once a routing number has been determined, in step 218, the application server 18 sends a USSD response message to the HLR 16. The HLR 16 forwards in the USSD Request message to the UE 22 (step 220). In certain embodiments, the USSD Request message is addressed to an application running on the UMTS Subscriber Identity Module (“USIM”) of the UE 22. The UE 22 may respond with an acknowledgement to the HLR 16, as is well known in the art (step 222). In step 224, this USSD response is then forwarded to the application server 18. Thus, a USSD session/dialog may be established between the application server 18 and the UE 22 via the HLR 16. Since a USSD session exists between the UE 22 and the application server 18, the UE 22 may reject any additional USSD requests until the USSD session ends. Additionally, in certain embodiments, if there is no acknowledgement is received before a response-timer (not shown) expires, then the request for automatic callback activation is rejected. This may also cover the situation where the destination network or destination mobile may not support either the USSD protocol or a USSD application mode.

In step 225, the UE 22 is directed to monitor the on-going call status. In certain embodiments, the UE 22 may receive an instruction to start the monitoring process. In other embodiments, an application running on the UE 22 may be pre-programmed to begin monitoring upon sending the acknowledgement back to the application server 18 (step 222). In either embodiment, when the on-going call on UE 22 is released, the UE 22 notifies the HLR 16 that the UE 22 is idle (step 226). In step 228, the HLR 16 forwards this message to the application server 18. Once the idle message is received by the application server 18, the USSD dialog/session between the UE 22 and the application server 18 is terminated.

The application server 18 may then use known techniques, such as anytime-interrogation of the HLR 16 to determine the current state of the UE 11. Such an interrogation is represented by an inquiry step 230 from the application server 18 and a response step 232 back to the application server 18. If the UE 11 is now idle, then in step 234 the application server 18 sends USSD notification to the UE 11 via the HLR 16 In some embodiments, the message may be addressed to the display. Subscriber A can then provide an indication (e.g., by pressing a single key), to setup a call from for the UE 11 to the UE 22 (step 236).

On the other hand, if the UE 11 is now busy, the application server 18 may send USSD request to a USSD application running on the USIM of the UE 11. In certain embodiments, the mobile application will be directed to report when the UE 11 goes IDLE. Thus, the UE 11 will wait for the on-going call to be released and then send an idle indication message back to the application server 18. In response, the application server 18 may send a USSD notification to the UE 11, notifying Subscriber A so that Subscriber A can attempt to call Subscriber B. However, if the UE 22 is once again in a busy state, then Subscriber A may need to re-enter the USSD automatic callback service code and then try again. Since a USSD session is established between the UE 11 and the application server 18, the UE 11 will reject any additional USSD requests until the session ends. The session is ended when the UE 11 sets up the call with the UE 22. Note that in some aspects of the disclosed invention, when is Subscriber A is notified that the Subscriber B is now IDLE, Subscriber A initiates the callback, so the callback may not be as completely automatic as described in 3GPP TS 23.093.

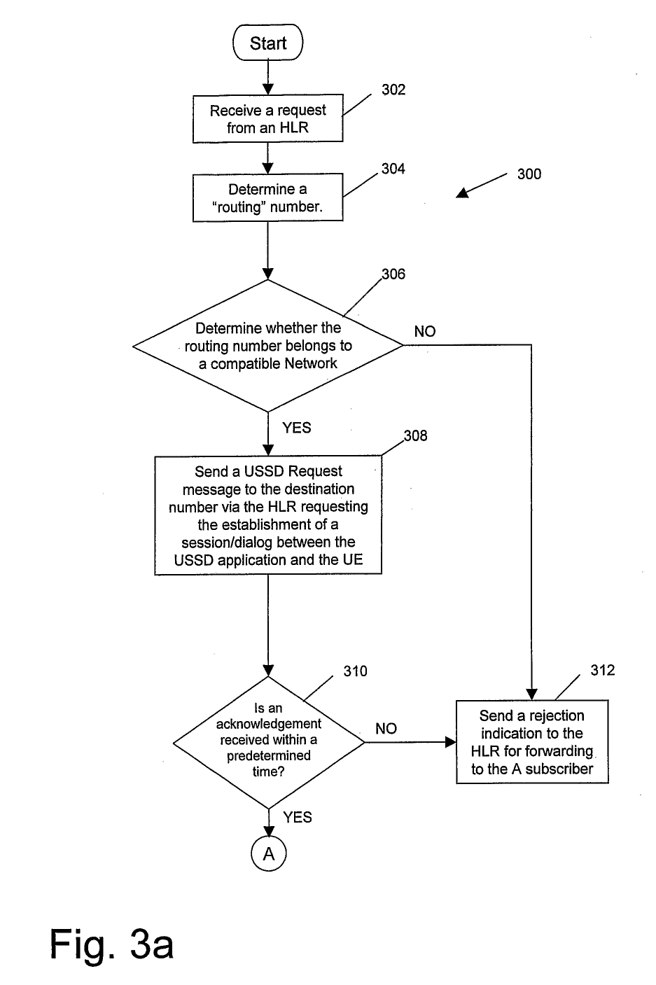

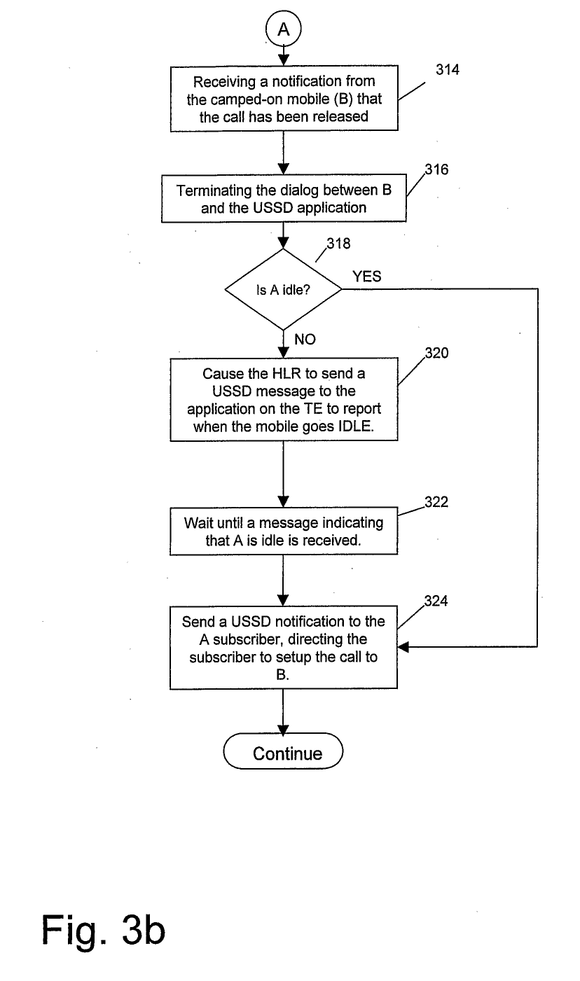

Turning now to FIG. 3a, there is a procedure 300 which may be implemented in various aspects of the application server 18. The procedure 300 generally starts when a USSD request has been received from an HLR (e.g., HLR 16). In other words, since this procedure is described with reference to the application server, step 302 of procedure 300 generally coincides with step 214 of the call flow describe in reference to FIG. 2. Thus, in step 302, the USSD application running on the application server 18 receives a request from an HLR containing, the called number (e.g., the phone number of the UE 22) and the MSISDN or telephone number of the UE 11 of the calling party (e.g, Subscriber A).

Before a USSD message can be sent to the User Equipment 22, in step 304, the application server 18 may determine a “routing” number for the call. In areas such as the United States, numbers can be “ported” between networks. So a number-series analysis may not be sufficient to determine whether the called number is a mobile number, or whether it has been ported. In such areas, the application server 18 may query a Number Portability (“NP”) database by sending the called number to an agent managing the NP database server. If the number has been ported, then a different number will be returned as a routing number. On the other hand, if the number has not been ported, then the query will return the called number as a routing number. In either case, the returned routing number can be used to route the USSD message to the UE 22. Obviously, step 304 may not be required in areas where numbers are not ported between networks.

In step 306, the process may determine whether the routing number belongs to a compatible network. In certain embodiments, the application server 18 can use a number analysis on the routing number to determine whether the routing number belongs to a recognized mobile network (i.e. a GSM or UMTS network utilizing compatible SIM/USIM's). If the routing number belongs to an unrecognized mobile network, then the process flows to step 312, where a rejection indication will be sent back to the UE 11. On the other hand, if the routing number belongs to a recognized network, then the process flows to step 308.

In step 308, the application server may generate and send a USSD Request message to the routing number (via the HLR). In this illustrative example, the message may be addressed to a USSD mobile application running on the USIM of the UE 22. The message requests the establishment of a USSD session/dialog between the application server 18 and the UE 22.

In step 310, a process may determine whether an acknowledgement has been received within a predetermined time. If there is no acknowledgement before a response-timer expires, then the request for automatic callback activation is rejected and the process flows to step 312 where a rejection indication is sent back to the HLR 16 for forwarding to the UE 11. The response-timer would expire, for instance, when the destination network or destination mobile does not support either USSD or the USSD application mode. On the other hand, if a USSD acknowledgement or other response is received within the predetermined time, the process continues at step 314 (FIG. 3b).

Turning now to FIG. 3b, which illustrates the continuation of the process 300. At step 314, the application server waits until it receives an idle indication message from the UE 22. The idle indication message indicates that the call on UE 22 has been released. Upon receiving the idle indication message, the application server terminates the USSD session with the UE 22 (step 316).

In step 318, the application server 18 may then determine if the UE 11 is idle. The determination of the state of UE 11 may be made by conventional methods such as by using anytime interrogation. If the UE 11 is idle, then the process flows to step 324. On the other hand, if the UE 11 is not idle, the process flows to step 320.

If the UE 11 is in a busy state, then in step 320, the application server 18 sends a USSD message to the HLR 16 for forwarding to a mobile application running on the USIM of the UE 11. In certain embodiments, the USSD message may direct the mobile application to monitor and report when the UE 11 is in an idle state. In step 322, the process waits for a message from UE 11 indicating that the UE is now idle. When the process receives an indication that the UE 11 is idle, in step 324, the process sends a USSD notification to the UE 11. Subscriber A may then be directed to attempt to call Subscriber B. If Subscriber B is once again busy, then Subscriber A may re-enter the USSD automatic callback service code and try again. Such a situation has been discussed in detail above in reference to FIG. 2.

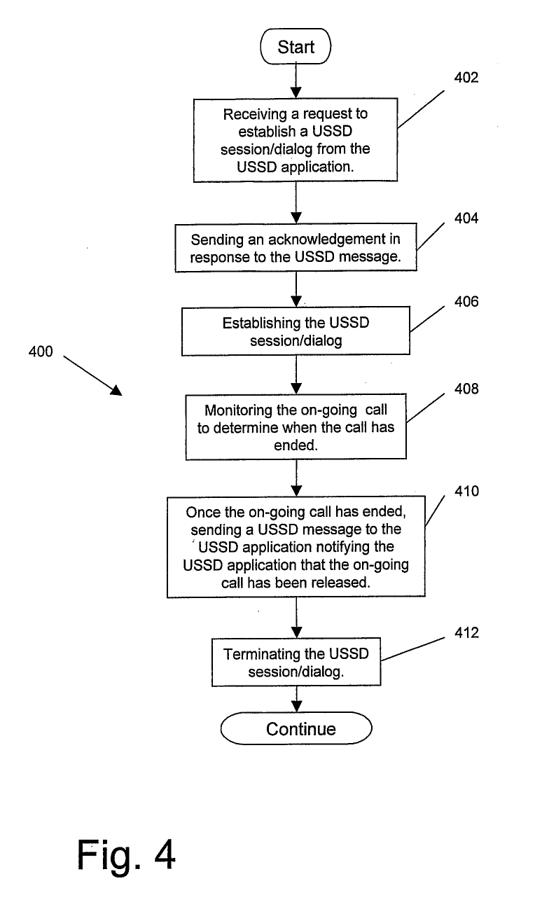

Turning now to FIG. 4, there is one method 400 which may be implemented in a mobile application running in the user equipment (UE 11 or UE 22), such as a USIM. The UE would be in the process of a call to some other user. The process begins at step 402, where the UE receives a request in the form of a USSD message from the USSD application server 18 to establish a USSD session/dialog with the application server. Assuming that the UE does not have another on-going USSD session, in step 404, the mobile application sends an acknowledgement in response to the USSD message to establish the USSD session/dialog. In step 406, a USSD session/dialog is established between the UE and the application server 18 in a conventional manner.

The process then monitors the state of the UE to determine when the on-going call has ended (step 408).

Once the on-going call has ended, in step 410, the process sends a USSD message to the application server 18 notifying the application that the on-going call has been released. In step 412, the USSD session/dialog is terminated in a conventional manner and the UE continues to operate in a conventional manner.

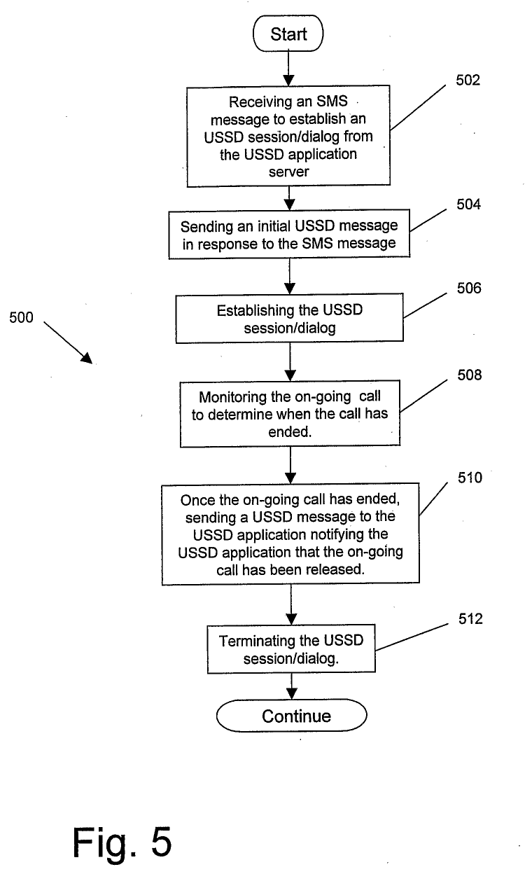

In alternative aspects of the present invention, the application server 18 may send a SMS message towards the called party number, with the SMS message containing the USSD application address, and the Calling Party Number, and the CCBS request code. This alternative aspect may also use an application mode addressing method. In such an embodiment, the UE for the called party would then initiate a USSD session toward the external USSD application. This may be a more robust way of contacting the Called Party, although there may be several seconds of additional latency. In this embodiment, the UE may implement a method illustrated in FIG. 5.

In FIG. 5, an alternative process or procedure 500 is discussed from the perspective of an application running on the users equipment, such as UE 11 or UE 22. The UE would be in the process of an on-going call to some other user. The process begins at step 502, where the UE receives a request in the form of a SMS message from the application server 18 to establish a USSD session/dialog with the application server. In step 504, the process sends an SMS acknowledgement in response to the SMS message to establish the USSD session/dialog. In step 506, a USSD session/dialog is established between the UE and the application server 18 in a conventional manner.

The process then monitors the state of the UE to determine when the on-going call has ended (step 508). Once the on-going call has ended, in step 510, the process sends a USSD message to the application server 18 notifying the application that the on-going call has been released. In step 512, the USSD session/dialog is terminated in a conventional manner and the UE continues to operate in a conventional manner.

Note that an alternate implementation could have the called UE (e.g. Subscriber B) automatically call the calling UE (e.g., Subscriber A) once the initial call is complete. However, if the calling UE calls the called UE, then Subscriber A will pay for the call in many countries. Subscriber B may not want to call Subscriber A back. Thus, in certain embodiments, Subscriber B may be given a message asking if Subscriber B wants to return the missed call, instead of automatically setting up the call.

In another aspect, a similar procedure may be applied to a wireline subscriber in the U.S. This method would have the USSD application send TCAP signaling to the exchange for Subscriber B, to request queueing on the phone line of Subscriber B. (This would use a similar protocol to an existing wireline feature called “CLASS Automatic Callback”.) When Subscriber B hangs up, the serving exchange would signal this event to the USSD application server. The USSD application server may then send an indication to Subscriber A to attempt another call to Subscriber B.

If the exchange serving Subscriber B does not support TCAP queueing request (i.e. CLASS Automatic Callback), then the USSD application server would reject the activation request as described previously.

In alternative embodiments, the SSAP protocol might also be supported in the USSD application server to allow a CCBS feature for inter-working with networks that do not support the USSD protocol, but provide support for TS 23.093.

The abstract of the disclosure is provided for the sole reason of complying with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the invention. When the word “means” is recited in a claim element, Applicant intends for the claim element to fall under 35 USC 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures, since they both perform the function of fastening. Claims that do not use the word means are not intended to fall under 35 USC 112, paragraph 6.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of assisting a completion of a call between a calling user equipment and a called user equipment, when the called user equipment is initially in a busy state, wherein the method is performed by a Unstructured Supplementary Services Data (“USSD”) application server, the method comprising:
receiving a request to complete the call from the calling user equipment, wherein the request includes a calling number and a called number;
sending a USSD request to the called user equipment requesting the establishment of a USSD session;
receiving a notification from the called user equipment indicating that the called user equipment is in an idle state; and
sending a USSD notification to the calling user equipment indicating that the called party user equipment is in an idle state.

2. The method of claim 1, further comprising sending an instruction to the called user equipment to send a notification to the USSD application server when the called user equipment is in an idle state.

3. The method of claim 1, further comprising:
determining whether the called number is a member of a compatible network;
if the called number is not a member of a compatible network, sending a rejection indication to the calling user equipment.

4. The method of claim 3, wherein the determining further comprises performing a number analysis on the called number to determine if the called number belongs to a compatible network.

5. The method of claim 3, wherein the determining further comprises:
determining if an acknowledgement responsive to sending the USSD request to the called user equipment has been received within a predetermined time.

6. The method of claim 1, further comprising determining a routing number for the called user equipment.

7. The method of claim 6, wherein the determining a routing number comprises querying a number portability database to receive the routing number associated with the called number.

8. The method of claim 1, further comprising sending an instruction to terminate the USSD session responsive to receiving a notification from the called user equipment indicating that the called user equipment is in an idle state.

9. The method of claim 1, further comprising:
determining if the calling user equipment is in a busy state, if the calling user equipment is in a busy state, then:
sending a USSD request to the calling user equipment requesting the establishment of a USSD session;
receiving a notification from the calling user equipment indicating that the called user equipment is in an idle state; and
sending a USSD notification to the calling user equipment indicating that the called party user equipment is in an idle state.

10. The method of claim 9, further comprising using interrogation techniques to determine the state of the calling user equipment.

11. The method of claim 9, further comprising sending an instruction to terminate the USSD session with the calling user equipment responsive to receiving a notification from the calling user equipment indicating that the calling user equipment is in an idle state.

12. The method of claim 1, wherein the request to complete the call is initiated by entering a USSD activation code on a keypad of the calling user equipment and entering a number associated with the called party.

13. The method of claim 1, wherein the request to complete the call is initiated by pressing a key on the keypad of the calling user equipment which retrieves a last number called for use as the called number.

14. A method of assisting a completion of a call between a calling user equipment and a called user equipment, when the called user equipment is initially in a busy state, wherein the method is performed by the called user equipment, the method comprising:
receiving a request from a Unstructured Supplementary Services Data (“USSD”) application server to establish a USSD session with the USSD application server;
sending an acknowledgement in response to receiving the request;
establishing a USSD session with the USSD application server;
monitoring the state of the called user equipment; and
sending a notification to the USSD application server when the called user equipment is in an idle state.

15. The method of claim 14 further comprising receiving an instruction to monitor the state of the called user equipment.

16. The method of claim 14 further comprising terminating the USSD session.

17. A method of assisting a completion of a call between a calling user equipment and a called user equipment, when the called user equipment is initially in a busy state, wherein the method is performed by the called user equipment, the method comprising:
receiving an Short Message Service (“SMS”) request from a Unstructured Supplementary Services Data (“USSD”) application server to establish a USSD session with the USSD application server;
sending an initial USSD message in response to receiving the SMS request;
establishing a USSD session with the USSD application server;
monitoring the state of the called user equipment; and
sending a notification to the USSD application server when the called user equipment is in an idle state.

18. The method of claim 17 further comprising receiving an instruction to monitor the state of the called user equipment.

19. The method of claim 17 further comprising terminating the USSD session.
